(19) United States
(12) Patent Application Publication
(10) Pub. No.: US 2005/0101342 A1
(43) Pub. Date: May 12, 2005

(54) Mobile phone including a wireless network module and a memory module

(76) Inventor: Pai-Ko Chuang, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,030

(22) Filed: Feb. 4, 2004

(30) Foreign Application Priority Data
Nov. 7, 2003 (TW) 092131294

(51) Int. Cl. H04B 7/00

(52) U.S. Cl. 455/550.1; 455/556.1; 455/41.2

(57) ABSTRACT

A mobile phone has a connection module, a switch module, a power module, a communication module, a wireless network module, and a memory module. The connection module connects the mobile phone to a host. The switch module connected to the connection module switches the connection between the mobile phone and the host. The power module provides power to the mobile phone. The communication module provides a wireless communication to the mobile phone. The wireless network module provides the wireless network to the host when the mobile phone connects to the host. The host stores the data to the memory module when the mobile phone connects to the host.

### BACKGROUND OF INVENTION

1. Field of the Invention

The present invention relates to a mobile phone, and more particularly, to a mobile phone including a wireless network module and a memory module.

2. Description of the Prior Art

As semiconductor technology matures overtime, the production costs of manufacture the electronic devices reduce dramatically. Therefore, its not uncommon to see a user possess several electronic devices that have different functionalities. For example, a business user needs a notebook computer to give a presentation to his client, a personal digital assistant (PDA) to arrange his schedule, a USB flash disk for storing data, and a mobile phone for keeping in contact with his clients. As a result, portability of the electronic devices is a very important factor for manufacturers to consider. In addition, many users prefer a multi-function electronic device instead of electronic products that have only a single function for fulfilling the requirements of communication, wireless network, data storage, etc.

Due to the continuous innovation and advancement of wireless communications, wireless network technology has been improved from IR transmission and radio frequency technology toward Voice Over Internet Protocol (VOIP) and wireless LAN technology. Generally speaking, the electronic devices that require wireless network functionality include notebook computers, PCs, PDAs, and mobile phones. The wireless network technology provides some practical values. For example, not long ago users could only access the Internet with their PCs or notebook computers at home or in their offices. At present, the users are able to access the Internet with their notebook computers via wireless base stations in airports, stations, or many other public places. However, since the mobile phone has a smaller bandwidth, the transmission rate is quite slow.

Therefore, the development of wireless communications is heading in two directions. The first direction is to add more functions in a single electronic product, and the other is to increase the transmission rate and to improve the bandwidth. For fulfilling the requirements of broadband wireless communications, the wireless communication providers build a large amount of base stations extensively in the airports, stations, or restaurants. For the users, however, they cannot access the Internet without carrying a mobile phone, a wireless Ethernet card, and a notebook. This is really inconvenient for the users.

### SUMMARY OF INVENTION

It is therefore a primary objective to provide a mobile phone having a wireless network module and a memory module for solving the above-mentioned problems.

According to the claimed invention, a mobile phone is provided. The mobile phone includes a connection module, a switch module, a power module, a communication module, a wireless network module, and a memory module. The connection module connects the mobile phone to a host. The switch module connected to the connection module switches the connection between the mobile phone and the host. The power module connects with the switch module and provides power to the mobile phone. The communication module provides a wireless communication to the mobile phone and connects with the switch module. The wireless network module connects with the switch module and provides the wireless network to the host when the mobile phone connects to the host. The host stores the data to the memory module when the mobile phone connects to the host.

In addition, the power module further includes a battery for storing power, and a power management unit connected to the battery and the communication module for providing power stored in the battery to the communication module. The communication module further includes a transmission control unit for controlling different functions of the mobile phone, a subscriber identity module connected to the transmission control unit for recording the subscriber data, and a communication antenna connected to the transmission control unit for transmitting and receiving radio waves. The wireless network module further includes a wireless network transmission unit connected to the switch module for transmitting data, and a network antenna connected to the wireless network transmission unit for transmitting and receiving the radio waves.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a mobile phone of the present invention connected to a host.

FIG. 2 is a schematic diagram of a mobile phone of the present invention connected to a host wirelessly.

FIG. 3 is a function block diagram of the mobile phone shown in FIG. 1.

### DETAILED DESCRIPTION

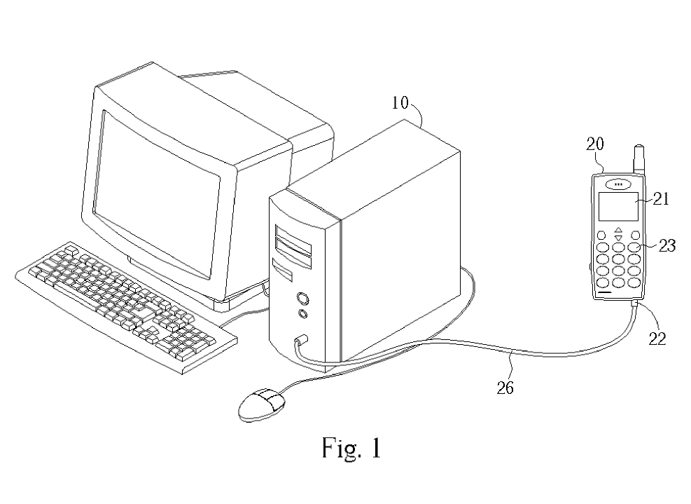

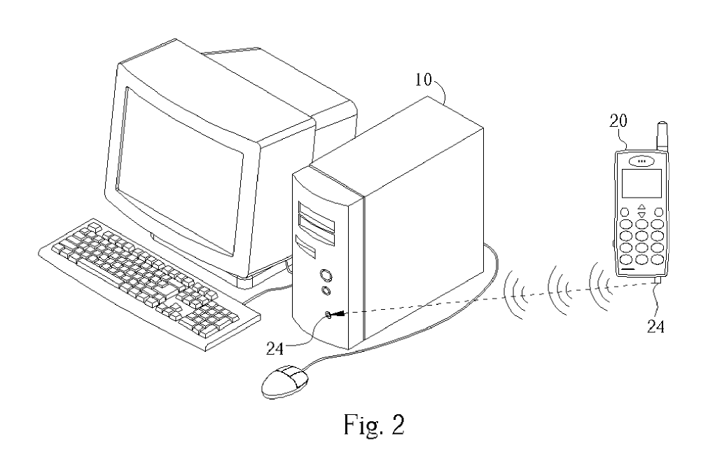

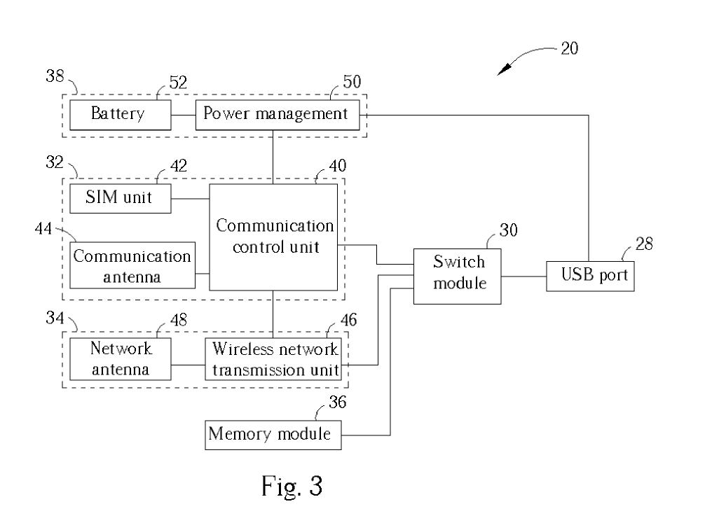

Please refer to FIG. 1 to FIG. 3. FIG. 1 is a schematic diagram of a mobile phone 20 of the present invention connected to a host 10; FIG. 2 is a schematic diagram of a mobile phone 20 of the present invention connected to a host 10 wirelessly; and FIG. 3 is a function block diagram of the mobile phone 20 shown in FIG. 1. The mobile phone 20, which includes a display unit 21 and an input unit 23, is connected to the host 10 via a connection module 22. The connection module 22 is connected to the mobile phone 20 and the host 10, via hard-wired connection or wireless connection. In a wireless case, the mobile phone 20 and the host 10 both include a wireless transceiver 24 as shown in FIG. 2. In a preferred embodiment of the present invention, a universal serial bus (USB) transmission line 26 is used to connect the mobile phone 20 and the host 10, as shown in FIG. 1. As shown in FIG. 3, the mobile phone includes a USB port 28, a switch module 30, a communication module 32, a wireless network module 34, a memory module 36, and a power module 38. The mobile phone 20 of the present invention not only provides a telephonic communication function, but a wireless network function and a flash disk function as well. The mobile phone 20 is connected to the host 10 via the USB port 28, and is switched to different functions via the switch module 30 connected to the USB port 28. The switch module 30 is either a USB switch or a USB Hub. The communication module 32, which includes a transmission control unit 40, a subscriber identity module (SIM) unit 42, and a communication antenna 44, is connected to the switch module 30 for providing a wireless communication function. The wireless network module 34, which includes a wireless network transmission unit 46 and a network antenna 48, is connected to the switch module 30 for providing a wireless network function while the mobile phone 20 is connected to the host 10. The memory module 36 is connected to the switch module 30 for allowing the host 10 to store data while the mobile phone 20 is connected to the host 10. The power module 38, which includes a power management unit 50 and a battery 52, is connected to the communication module 32 for providing power required by the mobile phone 20. Detailed description for illustrating the functions and connections of each element are given below.

The memory module 36 is a data storage unit including at least a semiconductor memory, which is most commonly a flash memory. The memory module 36 allows the host 10 to store data, and stores related software for the mobile phone 20 and the host 10, such as installation programs, application programs, and drivers. A USB switch is able to support four download ports, which is well known in the IT industry. However, practically these four download ports are started in order. The memory module 36 is predetermined as the first started device of the switch module 30 when the mobile phone 20 is connected to the host 10. In such a case, the host 10 is able to obtain the software, such as drivers, stored in the memory module 36.

The wireless network module 34 allows the host 10 to access the Internet where wireless network base stations are installed. The wireless network transmission unit 46 of the wireless network module 34 complies with the IEEE 802.11 standard. The network antenna 48 is connected to the wireless network transmission unit 46 for transmitting and receiving the radio waves.

The communication module 32 provides some main functions including telephonic communication, messaging, and Internet access for the mobile phone 20. The transmission control unit 40 is either a global system for mobile communications (GSM) transmission circuit or a code-division multiple access (CDMA) transmission circuit. As far as technology is concerned, the transmission control unit 40 generally refers to any standard communication transmission circuits from the second generation to the fourth generation. The transmission control unit 40 not only provides the communication function for the mobile phone 20, but also controls other functions of the mobile phone 20. For example, the transmission control unit 40 is able to switch off the wireless network module 34. Consequently, the host 10 will not remind the user of installing the drivers of the wireless network module 34 whenever the user does not need to use the wireless network module 34. In addition, the host 10 is able to access the Internet by use of the data transmission service provided by the Information Service Provider (ISP). The communication antenna 44, connected to the transmission control unit 40, can be a single band, dual band, or triple band antenna. The SIM unit 42 is connected to the transmission control unit 40 for reading and writing data of the SIM card. The SIM unit 42 also allows the service providers to record personal information, service charges, identification, and confidential data of the user.

The power module 38 mainly provides power to the communication module 32. The memory module 36 and the wireless network module 34 do not consume power when disconnecting from the host 10. While the memory module 36 and the wireless network module 34 are connected to the host 10, they can obtain power via the USB interface. The power management unit 50 is connected to the USB port 28 so that an external power source can recharge the battery 52 via the power management unit 50.

It can be seen that the mobile phone 20 of the present invention, which includes the communication module 32, the wireless network module 34, and the memory module 36, does not merely provide the telephonic communication function. While the mobile phone 20 is connected to a PC host, a PDA, or a notebook computer via the USB interface, the user can access the Internet by either using the data transmission service provided by the ISP or by using the wireless network module 34 in a place where the wireless network base stations are installed. In addition, the memory module 36 can store some important data or some application software, such as an e-mail system. In such a case, the user can connect the mobile phone 20 to any available hosts for accessing the Internet or for processing data.

The transmission control unit 40 is connected to the wireless network transmission unit 46 so that the mobile phone can control the wireless network module 34. While the user wishes to connect the mobile phone 20 to a computer host without starting the wireless network function, the wireless network function can be halted directly via the mobile phone 20. In addition, if the VOIP function is added, the user can select to start communication via the wireless network module 34 wherever wireless network communication is covered.

In comparison with the prior art, the present invention provides an integrated mobile phone that includes a built-in wireless network module and a built-in memory module, so that the requirements of telephonic communication, wireless networking, and data storage are fulfilled. In addition, for the communication service providers, they can install more base stations in large amounts while the mobile phone of the present invention is in common use.

Those skilled in the art will readily observe that numerous modifications and alterations of the device may be made while retaining the teachings of the invention. Accordingly, the above disclosure should be construed as limited only by the metes and bounds of the appended claims.

1. A mobile phone comprising:
a connection module for connecting the mobile phone to a host;
a switch module connected to the connection module for switching a connection between the mobile phone and the host;
a communication module connected to the switch module for providing wireless communication capability to the mobile phone;
a wireless network module connected to the switch module for providing a wireless network to the host when the mobile phone is connected to the host;
a memory module connected to the switch module for allowing the host to store data thereto when the mobile phone is connected to the host; and
a power module connected to the communication module for providing power to the mobile phone.

2. The mobile phone of claim 1 wherein the connection module comprises a radio transceiver so that the mobile phone and the host connect to each other wirelessly.

3. The mobile phone of claim 1 wherein the connection module comprises a port.

4. The mobile phone of claim 3 wherein the port is a universal serial bus (USB) port.

5. The mobile phone of claim 4 wherein the switch module is a USB switch or a USB hub.

6. The mobile phone of claim 1 wherein the power module further comprises:
a battery for storing power; and
a power management unit connected to the battery and the communication module for providing power stored in the battery to the communication module.

7. The mobile phone of claim 6 wherein the power management unit is capable of recharging the battery via the connection module while an external power supply is applied to the connection module.

8. The mobile phone of claim 1 wherein the communication module further comprises:
a transmission control unit for controlling the mobile phone;
a subscriber identity module connected to the transmission control unit for recording subscriber data; and
a communication antenna connected to the transmission control unit for transmitting and receiving radio waves.

9. The mobile phone of claim 8 wherein the transmission control unit is connected to the wireless network module for enabling and disabling the wireless network module.

10. The mobile phone of claim 6 wherein the transmission control unit is a global system for mobile communication (GSM) transmission circuit or a code-division multiple access (CDMA) transmission circuit.

11. The mobile phone of claim 1 wherein the wireless network module further comprises:
a wireless network transmission unit for transmitting network data; and
a network antenna connected to the wireless network transmission unit for transmitting and receiving radio waves.

12. The mobile phone of claim 11 wherein the wireless network transmission unit is a wireless transmission circuit complying with the IEEE 802.11 standard.

13. The mobile phone of claim 1 wherein the memory module is a flash memory.

14. A wireless communication device comprising:
a communication module comprising a communication antenna, a display unit, an input unit, and a transmission control unit, the communication antenna, the display unit, and the input unit being connected to the transmission control unit;
a memory module comprising a memory unit capable of storing data;
a power module connected to the communication module for providing power to the communication module;
a switch module having a plurality of ports, the switch module being connected to the communication module and the memory module; and
a connection module connected to the switch module for building a connection between the wireless communication device and a calculation device, the switch module connecting to the memory module and the communication module respectively via a first port and a second port, and the switch module enabling the plurality of ports in a predetermined order.

15. The wireless communication device of claim 14 wherein the wireless communication device further comprises a wireless network module connected to the switch module via a third port for providing a connection to a wireless local area network (LAN).

16. The wireless communication device of claim 15 wherein the power module further comprises:
a battery for storing power; and
a power management unit connected to the battery and the communication module for providing power stored in the battery to the communication module.

17. The wireless communication device of claim 16 wherein when the wireless communication device is connected to the calculation device via the connection module, and the power management unit is capable of connecting to an external power supply via the connection module and is capable of recharging the battery.

18. The wireless communication device of claim 15 wherein the wireless network module comprises:
a wireless network transmission unit for transmitting data; and
a network antenna connected to the wireless network transmission unit for transmitting and receiving radio waves.

19. The wireless communication device of claim 18 wherein the transmission control unit is connected to the wireless network transmission unit for controlling operations of the wireless network module.

20. The wireless communication device of claim 19 wherein the transmission control unit is controlled via the input unit for selecting operation modes of the wireless network module.

21. The wireless communication device of claim 15 wherein the memory unit comprises a flash memory.

22. The wireless communication device of claim 21 wherein the memory module stores drivers for the wireless communication device therein.

23. The wireless communication device of claim 22 wherein when the wireless communication device and the calculation device are connected together, the switch module enables the memory module for transmitting the drivers to the calculation device and installing the drivers in the calculation device so as to transmit signals between the calculation device and the wireless communication device.
